(19) United States
(12) Patent Application Publication
(10) Pub. No.: US 2023/0064672 A1
(43) Pub. Date: Mar. 2, 2023

(54) ISOTROPIC, CRACK-FREE STEEL DESIGN USING AN ADDITIVE MANUFACTURING METHOD

(71) Applicant: UNIVERSITÄT PADERBORN, Paderborn (DE)

(72) Inventors: Florian HENGSBACH, Paderborn (DE); Kay-Peter HOYER, Paderborn (DE); Mirko SCHAPER, Paderborn (DE); Anatolii ANDREIEV, Paderborn (DE)

(21) Appl. No.: 17/911,038

(22) PCT Filed: Mar. 10, 2021
(86) PCT No.: PCT/EP2021/056030

§ 371 Date: Sep. 12, 2022

(30) Foreign Application Priority Data
Mar. 10, 2020 (DE) 10 2020 106 517.5

(51) Int. Cl. B22F 1/05; B33Y 10/00; B33Y 40/10; B33Y 70/00; B22F 10/28; B22F 9/08; C22C 38/28; C22C 38/24; C22C 38/22; C22C 38/04; C22C 38/02; C22C 38/00

(52) U.S. Cl. CPC B22F 1/05; B33Y 10/00; B33Y 40/10; B33Y 70/00; B22F 10/28; B22F 9/082; C22C 38/28; C22C 38/24; C22C 38/22; C22C 38/04; C22C 38/02; C22C 38/002; C22C 38/001; B22F 2009/0824; B22F 2009/0876; B22F 2301/35

(57) ABSTRACT

The present invention relates to a metal powder for use within an additive manufacturing process, the powder comprising steel particles, wherein the steel particles comprise, in a proportion by weight greater than or equal to 0.01% by weight and less than or equal to 5% by weight, carbonitrides (C,N) and/or carbides (C) and/or nitrides (N) selected from the group consisting of titanium, zirconium or mixtures thereof. Furthermore, the present invention relates to a method for producing a steel powder suitable for use within an additive manufacturing process and to the use of the steel powder according to the invention in an additive manufacturing process.

The present invention relates to a metal powder for use within an additive manufacturing process, the powder comprising steel particles, the steel particles comprising, in a proportion by weight of greater than or equal to 0.01% by weight and less than or equal to 5% by weight, carbonitrides (C,N) and/or carbides (C) and/or nitrides (N) selected from the group consisting of titanium, zirconium or mixtures thereof. Furthermore, the present invention relates to a method for producing a steel powder suitable for use within an additive manufacturing process and to the use of the steel powder according to the invention in an additive manufacturing process.

Additive manufacturing of workpieces has become increasingly important in manufacturing technology in recent years. Additive manufacturing is used to produce workpieces by sequentially adding substances, usually in layers. Traditional subtractive manufacturing processes, such as milling, machining, or turning, work out the shape of the workpiece by removing substance from a larger blank. Additive manufacturing in the industrial environment offers a high degree of design freedom, even for demanding applications and complex geometries. Single pieces can be produced at economically justifiable costs, which ultimately saves storage and tooling costs.

In principle, a large number of different substances can be processed additively. In 3D printing, for example, plastics are heated above their melting temperature and extruded layer by layer or point by point from a nozzle to form a molded part. Metals can also be processed additively. Metals, for example, can be added to workpieces in the form of a powder in a powder bed using thermal processes. In general, the application of powder bed-based additive manufacturing technologies enables the production of highly complex geometries, also based on a layer-by-layer material application. This process can also be referred to as multilayer micro welding. During production, a high-power laser or electron beam exposes the contour of the component belonging to the current layer in the powder bed and briefly melts the relevant area locally. After each layer, the powder bed is lowered further, and a new layer of powder is applied, smoothed, and again locally melted until the component is finished.

Currently, this process can only be used to produce components from materials that are easy to weld. However, additively manufactured components fabricated a crystallographic and a morphologic preferred orientation. The preferred growth of the grains and their preferred orientation lead to different mechanical properties under horizontal or vertical loading. The orientation-dependent mechanical properties are disadvantageous since the anisotropy makes the additively manufactured parts and components significantly more difficult to design mechanically.

Steel, in particular, is difficult to process by additive manufacturing, as the manufactured components usually exhibit microcracks. This can be attributed to the fact that during processing, rapid heating and cooling induces large residual stresses in the melting and in the surrounding region, which result in undesirable solidification, melting and embrittlement cracks. Ultimately, these cracked components cannot be used in practice or can only be used with difficulty, which greatly limits the usability of the manufactured components.

Modified laser sintering manufacturing processes have been proposed to reduce anisotropy and improve the mechanical properties of additively manufactured metal parts. In order to avoid micro-cracks, the state of the art tries to achieve better results by reducing the grain size of the metal powders used, especially for aluminum components. It is assumed that this measure distributes laser-induced stresses over many smaller grains instead of just a single, larger one. This should improve the susceptibility of the workpieces to cracking. The addition of nanoparticles as grain refiners to aluminum powder is currently being researched exclusively using the example of high-strength aluminum alloys in the field of additive manufacturing. The approach is to apply further ceramic and/or metal nanoparticles to the surface of the aluminum particles. The process includes the following steps: Atomize metal powder, de-agglomerate nanoparticles in water, mix the metal powder with nanoparticle suspension, dry metal powder-nanoparticle suspension and finally, sieve the dry metal-nanoparticle mixture. In addition to the complicated process of metal powder modification, the homogeneous distribution of the nanoparticles throughout the powder must also be considered critical.

Such solutions, known from the prior art, can offer further potential for improvement, especially concerning the simplicity of the manufacturing process of the metal powders that can be used, as well as the reproducibility and the isotropy of the mechanical properties of the workpieces obtained by means of the metal powders.

It is, therefore the task of the present invention to at least partially overcome the disadvantages known from the prior art. In particular, it is the task of the present invention to specify the composition of a metal powder with which mechanically isotropic and crack-free workpieces can be manufactured via additive manufacturing. In addition, it is the task of the present invention to specify a manufacturing process for the metal powders that can be used.

The task is solved by the features of the respective independent claims, directed to the product according to the invention, the process according to the invention and the use of the product according to the invention. Preferred embodiments of the invention are indicated in the subclaims, in the description or in the figures, whereby further features described or shown in the subclaims or in the description or in the figures may individually or in any combination constitute an object of the invention, as long as the context does not clearly indicate the contrary.

According to the invention, the problem is solved by a metal powder suitable for use within an additive manufacturing process, the powder comprising steel particles, the steel particles comprising carbonitrides (C,N) and/or carbides (C) and/or nitrides (N) in a proportion by weight of greater than or equal to 0.01% by weight and less than or equal to 5% by weight selected from the group consisting of titanium, zirconium or mixtures thereof. Surprisingly, it was found that the above metal powders can be processed in additive sintering processes to produce crack-free workpieces with isotropic mechanical properties. Thus, metallurgic micro-alloy modifications are obtained by the steel powder used, which in particular exhibit direction-independent mechanical properties. Without being bound by theory, this is achieved according to the invention by adding titanium or zirconium to, in particular, medium- and high-carbon steel powders. The alloy modification by the presence of titanium, carbon and nitrogen thus forms the basis that all steels can be processed using additive manufacturing. The addition of titanium is significantly more cost-effective than the addition of nanoparticles in the additive manufacturing of aluminum workpieces described in the prior art.

The metal powder, according to the invention, comprises steel particles. In this case, the metal powder is a bulk material consisting of many, non-contiguous, individual particles, the individual particles usually not having a single size, but a size distribution. The powder is a metal powder in cases where the metal content of the powder constituents is greater than or equal to 50% by weight, further preferably greater than or equal to 75% by weight, and further preferably greater than or equal to 90% by weight. The steel particles or the entire constituents of the powder may be more or less spherical in shape, but need not have a uniform or regular geometry. Preferably, the size of the particles in the metal powder can be from, for example, 10 nm to 100 μm. The metal powder comprises steel particles, steel particles being understood to mean powder particles or powder particles with a composition of an iron alloy with a carbon content of between 0.002% and 4.0%. The term steel particles complies in particular with the definition of steel according to DIN EN 10020:2000-07—Definitions for the classification of steels—which states that steel is a material whose iron content by mass is greater than that of any other element, whose carbon content is generally less than 2% and which contains other elements. A limited number of chromium steels may contain more than 2% carbon, but 2% is the usual limit between steel and cast iron. The chromium steels with higher than the 2% carbon content also fall under the steel term used in the invention. In addition to iron and carbon, the steel particles may have other metallic or non-metallic alloying constituents, which are known to the person skilled in the art in the field of the various steel modifications.

The steel particles of the metal powder comprise, in a proportion by weight greater than or equal to 0.01% by weight and less than or equal to 5% by weight, carbonitrides (C,N) and/or carbides (C) and/or nitrides (N) selected from the group consisting of titanium, zirconium or mixtures thereof. Titanium and/or zirconium is present in the iron alloy as an essential component, which is present with the carbon present in the steel alloy as titanium or zirconium carbide or with the carbon and nitrogen present in the steel as carbonitride or only as nitride. However, due to the carbon content, carbonitrides will essentially form. The titanium or zirconium forms an iron alloy containing titanium and/or zirconium with the steel alloy and is thus not present purely physically as a separate particle bonded or unbonded to the surface of the steel particles. The proportions of the individual alloy constituents can be quantitatively determined, for example, by X-ray fluorescence methods, such as ED-RFX methods. In a preferred embodiment, the metal powder may comprise titanium carbonitrides Ti(C,N), titanium nitrides Ti(N) and/or titanium carbides Ti(C) in an amount greater than or equal to 0.05 wt% and less than or equal to 4.5 wt%, preferably greater than or equal to 0.1 wt% and less than or equal to 3 wt%, further preferably greater than or equal to 0.2 wt% and less than or equal to 2.5 wt%. The corresponding Zr compounds can also be incorporated in the same weight ratios.

In a preferred embodiment of the metal powder, the metal powder may have particles with a mean particle diameter (D50) obtained via dynamic laser light scattering of greater than or equal to 10 nm and less than or equal to 100 μm. To obtain a metal powder that can be processed into particularly suitable additively manufactured workpieces, it has been found to be advantageous for the metal powder to have particles with particle diameters as indicated above. The metal powder thus comprises steel powder particles which have a size distribution in which the number averaged particle diameter lies within the range given above. The D50 quantile is given here. The particle size distribution can be measured by dynamic laser light scattering on the powder itself. Preferably, the mean particle diameter can further be greater than or equal to 1 μm and less than or equal to 50 μm. This size distribution can contribute to particularly low-crack workpieces with especially high and isotropic mechanical strength values.

In a preferred embodiment of the metal powder, the titanium and/or zirconium weight fraction in the metal powder may be greater than or equal to 0.01 wt% and less than or equal to 2.0 wt%. The advantages of the metal powder according to the invention can result even with small admixtures of titanium and/or zirconium to the steel alloy. This provides a particularly favorable base material for additive manufacturing. Higher titanium and/or zirconium contents by weight can unnecessarily increase the cost of the metal powder. Lower titanium and/or zirconium contents in the metal powder can contribute to only a very slight improvement in the mechanical properties of the workpiece produced, for example, by laser sintering. Furthermore, preferably, the titanium and/or zirconium weight fraction in the steel alloy can be greater than or equal to 0.1% by weight and less than or equal to 1.25% by weight.

Within a preferred characteristic of the metal powder, the metal powder can have a carbon content of greater than or equal to 0.25% by weight and less than or equal to 4% by weight. In particular for steel alloys with the above carbon content, the metal powder according to the invention can be sintered together to form particularly mechanically stable workpieces. These carbon contents are particularly suitable for laser sintering. Lower carbon contents can result in the workpiece having only insufficient strength. Higher carbon contents can contribute to the sintered workpiece becoming too brittle. Further preferred, the carbon content can be greater than or equal to 0.5% by weight and less than or equal to 2.5% by weight.

Within a preferred aspect of the metal powder, the steel particles may have a base composition for tool steel according to 1.2344 H13. In particular, tool steel can exhibit a particular suitability for additive processes by means of a titanium and/or zirconium additive. For this steel grade, mechanically very stable workpieces can be obtained in which, in particular, the mechanical properties show no or only very slight directional dependence. Tool steel 1.2344 H13 can in particular have a composition according to the following table:

| C | Si | Mn | P | S | Cr | Mo | V |
|---|---|---|---|---|---|---|---|
| 0.35-0.42 | 0.8-1.2 | 0.25-0.5 | 0-0.03 | 0-0.02 | 4.8-5.5 | 1.2-1.5 | 0.85-1.15 |

The values given represent in each case the lower and upper limits in wt.%. An “average” composition for tool steel can result, for example, in C 0.4; Mn 0.4; Si 1.0; Cr 5.25; Mo 1.35 and V 1.0 wt. %.

Further according to the invention is a method for producing a steel powder suitable for use within an additive manufacturing process, said method comprising at least the steps of: a) preparing a melt of steel, titanium and/or zirconium in an inert gas atmosphere; b) dropping the melt through a nozzle; and c) atomizing and cooling the droplets in a nitrogen stream to obtain a powder. Surprisingly, it has been shown that metal powders are obtainable via the above process, which are particularly suitable for use in additive manufacturing processes. The process produces homogeneous metal powders in which, in particular, the titanium and/or zirconium content is uniformly distributed. Steel alloys are therefore obtained which, in addition to a suitable size distribution in additive manufacturing processes, lead to particularly isotropic and mechanically stable workpieces. The metal or steel powder is obtained via a gas atomization process in which a melt is atomized with nitrogen as a high-pressure atomization gas. The nitrogen precipitates titanium and/or zirconium carbonitrides despite the very high cooling rate during powder atomization. In addition, titanium and/or zirconium and carbon from the steel alloy form high-melting titanium and/or zirconium carbides. Both modifications result in significant grain refinement being induced in the subsequently manufactured additive component, so that the desired properties—crack-free and direction-independent mechanical properties—are present. In a preferred embodiment, the metal powder according to the invention can be obtained via the process according to the invention.

In process step a), a melt of steel, titanium and/or zirconium is produced in an inert gas atmosphere. The melt of steel, titanium and/or zirconium can be obtained, for example, by heating the steel and the titanium/zirconium together. The melt is heated until there is a homogeneous distribution of the titanium and/or zirconium in the steel. The homogeneous distribution of the titanium and/or zirconium in the steel can be assisted by further mechanical steps, such as stirring the melt or using an alternating magnetic field. The melt is produced in a protective gas atmosphere, for example in an inert, preferably inert gas atmosphere, to prevent an unwanted change in the composition of the melt due to air-oxygen. In this process step, the total carbon content of the molten steel alloy can be influenced by the further addition of carbon. For example, it is possible that the titanium and/or zirconium is added to the melt as a carbon compound. However, it is also conceivable that titanium and/or zirconium are added separately to the molten steel as a metallic component and carbon. For both embodiments, it should be noted that a homogeneous distribution of both the titanium and/or zirconium and the carbon is important for a homogeneous metal powder.

In process step b), the molten metal is dropped through a nozzle. After the homogeneous melt has been produced, the molten metal is dropped through a nozzle. Depending on the design of the nozzle and the pressure, different diameters of the metal particles can be set.

In process step c), the droplets are atomized and cooled in a nitrogen stream to obtain a powder. The metal alloys dropped through the nozzle are converted into the metal powder of the invention by atomization in a nitrogen stream. Depending on the embodiment, the composition of the metal alloys and the size of the obtainable steel particles can be regulated via the amount and pressure of the nitrogen used.

Within a preferred embodiment of the process, the protective gas atmosphere in process step a) can be an argon atmosphere. In particular, the use of argon as a protective gas in process step a), can contribute to a particularly reproducible production of metal powders.

Within a preferred aspect of the process, the carbon content of the melt can be adjusted to greater than or equal to 0.2 wt% and less than or equal to 4 wt% in manufacturing step a) by adding a carbon source. To obtain a particularly consistent melt, it has proved advantageous in cases where the steel has too low a carbon content to add this to the melt. Preferably, the additional carbon content can be added by adding pure carbon. This can be advantageous over an embodiment in which the carbon is added to the molten bath together with the titanium and/or zirconium.

In a preferred embodiment of use, the metal powder can be used in a laser sintering process, whereby the powder is preheated to a temperature of greater than or equal to room temperature and less than or equal to 500° C. by means of a jacket heater before laser sintering. Particularly homogeneous and mechanically stable additively manufactured workpieces can be obtained by using the steel powders of the invention, especially in laser sintering processes. For use in laser sintering processes, it has also proved to be particularly advantageous that, before melting the steel powder by means of a laser, the metal powder is preheated to the temperature range indicated above by means of a heater or heat source. In combination with the steel powders of the invention, this measure can lead to particularly crack-resistant workpieces during laser sintering. In particular, the workpieces can also be crack-free and exhibit isotropic mechanical properties.

Further advantages and advantageous embodiments of the objects according to the invention are illustrated by the drawings and explained in the following description. It should be noted that the drawings are descriptive only and are not intended to limit the invention.

They show:

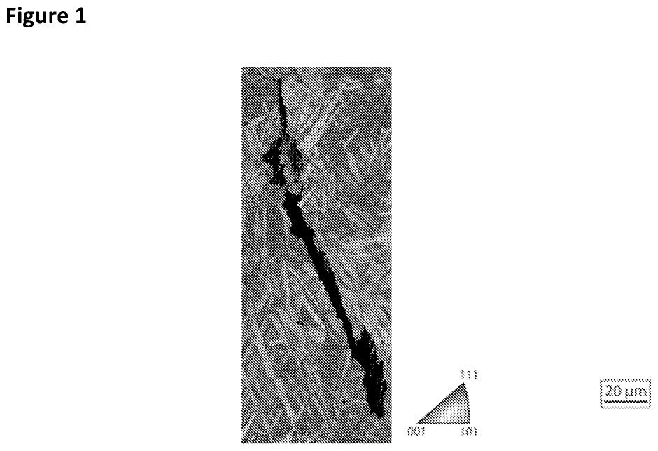

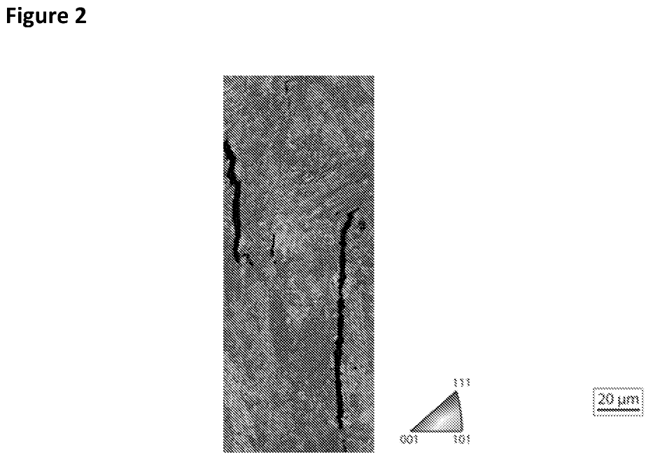

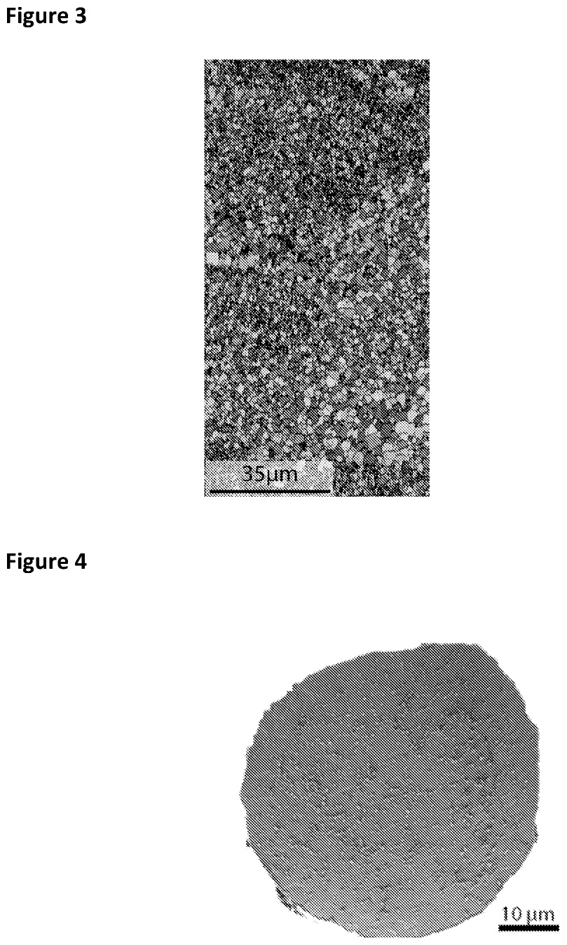

FIG. 1 the morphological image of a steel part produced via laser sintering obtained from a prior art steel powder; FIG. 2 the morphological image of a steel part produced via laser sintering, wherein the pow-der bed was heated before the actual laser sintering; FIG. 3 the morphological image of a steel part produced via laser sintering obtained from a steel powder according to the invention;

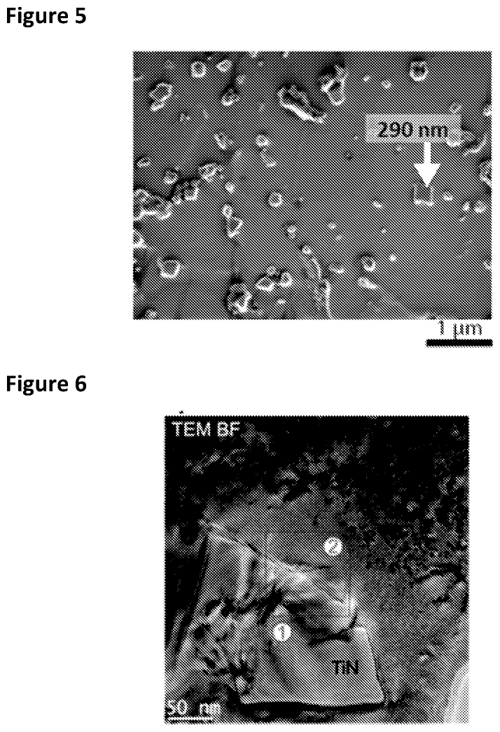

FIG. 4 a transverse section of a metal particle according to the invention with finely distributed cubic titanium nitrides; FIG. 5 a transverse section of a metal particle according to the invention with finely dispersed cubic titanium nitrides; FIG. 6 transmission electron micrographs of a Titanium nitride particle in a steel matrix ac-cording to the invention.

FIG. 1 shows a workpiece produced by a prior art laser sintering process. The workpiece was made from H13 tool steel using a powder bed process and the H13 steel powder had no other additives. The powder bed was heated to a temperature of 200° C. before sintering. In a microscopic image, the workpiece shows anisotropy in the joint and a strong tendency to crack.

FIG. 2 shows a workpiece produced by a laser sintering process. The workpiece was made of H13 tool steel by a powder bedding process. The H13 steel powder did not contain any additives other than the usual alloying constituents. In contrast to FIG. 1, the powder bed was heated to a temperature of 400° C. before laser sintering. The workpiece shows anisotropy in a photograph, but this is less than the anisotropy shown in FIG. 1. The cracking tendency is reduced compared to the prior art, but cracks still show. In addition, a more or less large isotropy of the domains is still evident.

FIG. 3 shows a section through a workpiece produced by a laser sintering process. The powder bed was heated to a temperature of 200° C. before sintering. The workpiece was produced from tool steel H13 with a titanium addition of 0.8% by weight by means of a powder bed process. By adding titanium to steel, a fine grain is produced so that the micro-crack susceptibility of the sintered steel can be completely avoided. The result is a homogeneous workpiece with small, isotropic domains, which exhibits significantly improved mechanical properties, in particular compared with FIG. 1.

FIGS. 4-6 show the heterogeneous fine grain of a medium carbon CrMoV tool steel with a titanium content of 0.9 wt% and a nitrogen content of 0.05 wt%. The chemical composition of the steel is given by:

| Element | Atomic weight | Weight-% | Mol-% |
|---|---|---|---|
| Fe | 55.8 | 87.6 | 84.6 |
| Cr | 51.9 | 5.1 | 5.9 |
| Mo | 98.9 | 3.5 | 2.2 |
| V | 50.9 | 1.0 | 1.3 |
| Mn | 54.9 | 0.3 | 0.4 |
| Si | 28.0 | 0.8 | 1.9 |
| C | 12.0 | 0.3 | 2.0 |
| Ti | 47.8 | 0.9 | 1.1 |
| N | 14.0 | 0.05 | 0.2 |
| P | 30.9 | 0.01 | 0.02 |
| S | 32.0 | 0.003 | 0.005 |

FIG. 4 shows a cross-section of a metal particle according to the invention with finely divided cubic titanium nitrides.

FIG. 5 shows a transverse section of a metal particle according to the invention with finely divided cubic titanium nitrides. The crystal highlighted by the arrow has an extension of about 290 nm.

FIG. 6 shows a transmission electron micrograph of a titanium nitride particle in the steel matrix. The lattice parameter difference of the nucleating agent to the matrix is below about 10% and thus produces an effective grain refinement.

1. A metal powder for use within an additive manufacturing process, characterized in that said powder comprises steel particles, said steel particles comprising, at a weight fraction greater than or equal to 0.01 wt% and less than or equal to 5 wt%, carbon nitrides (C,N) and/or carbides (C) and/or nitrides (N) selected from the group consisting of titanium, zirconium or mixtures thereof

2. Metal powder according to claim 1, wherein the metal powder comprises particles having an average particle diameter (D50) obtained via dynamic laser light scattering of greater than or equal to 10 nm and less than or equal to 100 μm.

3. Metal powder according to any one of the preceding claims, wherein the titanium and/or zirconium weight fraction in the metal powder is greater than or equal to 0.01 wt% and less than or equal to 2.0 wt%.

4. Metal powder according to any one of the preceding claims, wherein the metal powder has a carbon content of greater than or equal to 0.25 wt% and less than or equal to 4 wt%.

5. Metal powder according to any one of the preceding claims, wherein the steel particles comprise a base composition for tool steel according to 1.2344 H13.

6. Process for the preparation of a steel powder for use within an additive manufacturing process, characterized in that the process comprises at least the steps of:
a) preparing a melt of steel, titanium and/or zirconium in an inert gas atmosphere;
b) dropping the melt through a nozzle; and
c) atomizing and cooling the drops in a nitrogen stream to obtain a powder.

7. Process according to claim 6, wherein the inert gas atmosphere in process step a) is an argon atmosphere.

8. Process according to claim 6 or 7, wherein in process step a) the carbon content of the melt is adjusted to greater than or equal to 0.2 wt% and less than or equal to 4 wt% by adding a carbon source.

9. Use of a metal powder according to any one of claims 1-4 in an additive manufacturing process.

10. Use according to claim 9, wherein the metal powder is used in a laser sintering process, wherein the powder is preheated to a temperature of greater than or equal to 100° C. and less than or equal to 500° C. by means of a cladding heater prior to laser sintering.
